(19) United States
(12) Patent Application Publication
(10) Pub. No.: US 2009/0011706 A1
(43) Pub. Date: Jan. 8, 2009

(54) Near field RF communicators and near field communications-enabled devices

(75) Inventors: Robin Wilson, Gloucestershire (GB); David Miles, Gloucestershire (GB)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Innovision Research & Technology PLC, Gloucestershire (GB)

(21) Appl. No.: 12/283,535

(22) Filed: Sep. 12, 2008

Related U.S. Application Data
(63) Continuation-in-part of application No. PCT/GB2007/001918, filed on May 23, 2007.

(30) Foreign Application Priority Data
May 23, 2006 (GB) 0610227.1
Sep. 13, 2007 (GB) 0717880.9

(51) Int. Cl. H04B 5/00

(52) U.S. Cl. 455/41.1

(57) ABSTRACT

A near field RF communicator has an inductive coupler (10) to enable inductive coupling with a magnetic field of an RF signal. A demodulator (102) extracts modulation from an inductively coupled magnetic field. A power provider (109) provides a first power supply for the communicator independent of any inductively coupled signal while a power deriver derives a second power supply from an RF signal inductively coupled to the antenna. A regulator (206; 1302) regulates a voltage supplied by at least one of the first and second power supplies on the basis of a comparison with a reference voltage. A modulator (M) is provided to modulate an inductively coupled magnetic field with data to be communicated via the inductive coupling. In an example, a regulator controller is provided to prevent operation of the regulator in the event of a magnetic field amplitude below a predetermined level or the presence of modulation.

### CROSS-REFERENCE TO RELATED APPLICATIONS

This application is a continuation-in-part of PCT Patent Application No.: PCT/GB2007/001918 filed May 23, 2007 which designates the U.S. and was published in English and is hereby incorporated by reference herein.

Said PCT application claims priority of UK Patent Application No. 0610227.1, filed May 23, 2006, which is hereby incorporated by reference herein.

This application claims priority of UK Patent Application No. 0717880.9, filed Sep. 13, 2007, which is hereby incorporated by reference herein.

### BACKGROUND OF THE INVENTION

This invention relates to near field RF communicators and near field communications-enabled devices comprising such communicators.

Near field RF (radio frequency) communication requires an antenna of one near field RF communicator to be present within the alternating magnetic field (H field) generated by the antenna of another near field RF communicator by transmission of an RF signal (for example a 13.56 Mega Hertz signal) to enable the magnetic field (the H field) of the RF signal to be inductively coupled between the communicators. The RF signal may be modulated to enable communication of control and/or other data. Ranges of up to several centimetres (generally a maximum of 1 metre) are common for near field RF communicators.

Near field communication in the context of this application may be referred to as near-field RF communication, near field RFID (Radio Frequency Identification) or near-field communication. A near field RF communicator may be an initiator near field RF communicator, such as an RFID transceiver, that is capable of initiating a near field RF communication (through transmission or generation of an alternating magnetic field) with another near field RF communicator; a target near field RF communicator, such as an RF transponder (sometimes known as a tag), that is capable of responding to initiation of a near field RF communication by another near field RF communicator; or an NFC communicator that is both an initiator and target and that in an initiator mode is capable of initiating a near field RF communication (through transmission or generation of an alternating magnetic field) with another near field RF communicator and in a target mode is capable of responding to initiation of a near field RF communication by another near field RF communicator.

Communication of data between NFC communicators may be via an active communication mode in which the NFC communicator transmits or generates an alternating magnetic field modulated with the data to be communicated and the receiving NFC communicator responds by transmitting or generating its own modulated magnetic field. Communication of data between NFC communicators may be via a passive communication mode in which one NFC communicator transmits or generates an alternating magnetic field and maintains that field and the responding NFC communicator modulates the magnetic field to which it is inductively coupled with the data to be communicated, for example by modulating the load on the inductive coupling (“load modulation”). Near field RF communicators may also communicate actively or passively. Active communication is where communication requires the near field RF communicator to have an internal power source available to it. Passive communication is where a near field RF communicator derives a power supply from a received magnetic field. Generally an RF transceiver will use active communication while an RF transponder will use passive communication. An NFC communicator may use either active or passive communication.

A near field RF communicator may be independently powered, that is it may have its own power source or access to a host power source. Alternatively or additionally a near field RF communicator may be designed to derive at least part of is power from an inductively coupled RF field (as described above for passive communication). Generally RF transceivers have their own power source or access to a host power source while RF transponders will generally derive their power supply from an inductively coupled RF field.

The present application is concerned in particular with NFC communicators and RF transponders (target devices) that are capable of deriving power for operation of part or whole of their communications functionality from an inductively coupled RF field (magnetic field). Examples of such near field RF communicators are RF transponders and NFC communicators operating in target mode. For simplicity, the phrase “responsive near field RF communicator” will be used below to encompass any near field RF communicator capable of deriving power for operation of part or whole of its communications functionality from an inductively coupled RF field or magnetic field.

Examples of near field RF communicators are defined in various standards, for example ISO/IEC 18092 and ISO/IEC 21481 for NFC communicators, and ISO/IEC 14443 and ISO/IEC 15693 for other near field RF communicators.

Near field RF communicators may be provided as standalone or discrete devices (for example an RF transponder or tag may be included within a key fob, poster or other media) or may be incorporated within or coupled to or otherwise associated with larger electrical devices or hosts (referred to below as near field RF communications-enabled devices). When incorporated within a larger device or host, a near field RF communicator may be a discrete entity or may be provided partly or wholly by functionality within the larger device or host. Examples of such larger devices or host devices are, for example, cellular telephone devices, portable computing devices (such as personal digital assistants, notebooks, lap-tops), other computing devices such as personal or desk top computers, computer peripherals such as printers, or other electrical devices such as portable audio and/or video players such as MP3 players, IPODs®, CD players, DVD players, consumer products such as domestic appliance or personal care products and other electrical and electronic devices, apparatus or systems. Some areas of application are payment systems, ticketing systems (for example RF transponders may be carried by tickets such as parking tickets, bus tickets, train tickets or entrance permits or entrance tickets) or in ticket checking systems, toys, games, posters, packaging, advertising material, product inventory checking systems and so on.

When a responsive near field RF communicator such as a near field RF transponder is within the alternating magnetic field (H field) generated by the antenna of an initiator near field RF communicator (an RFID transceiver or NFC communicate operating in initiator mode) transmitting an RF field, the alternating magnetic field will be inductively coupled to the antenna of the responsive near field communicator. A responsive near field RF communicator may derive power from the coupled RF field and, once sufficient power has been derived, respond to the initiator near field RF communicator, for example through modulation of the received RF field.

Unlike RFID readers, NFC communicators have to operate in both a passive and active mode. Under certain circumstances when operating in passive mode the NFC communicator may have to derive a power source from a magnetic or H field received from a second near field RF communicator. For example, where the NFC communicator is comprised within an NFC communications enabled devices, for example a mobile telephone, under normal operation the NFC communicator will be able to derive a power supply from the battery, fuel cell or other power source within the NFC communications enabled device. However if that battery or power source is removed or fails, the NFC communicator will then need to derive operating energy from a received magnetic or H field. The strength of the received magnetic or H field can not be controlled or anticipated in advance and therefore there is the risk that the circuits of the NFC communicator will be damaged where the received field strength is particularly high.

### SUMMARY OF THE INVENTION

An aspect of the present invention provides an NFC communicator or other responsive near field RF communicator that alleviates at least some of the aforementioned problem. An aspect of the invention provides a regulation circuit for an NFC communicator which enables minimisation of any high field strength effects on the remaining circuits of the NFC communicator.

In one aspect, the present invention provides an NFC communicator comprising: an antenna to inductively couple to the H field of an RF signal; a power provider to provide a first power supply for the NFC communicator independent of any inductively coupled signal; a power deriver to derive a second power supply for the NFC communicator from an RF signal inductively coupled to the antenna; and a regulator to regulate a voltage supplied by at least one of the first and second power supplies. In an embodiment, the NFC communicator further comprises a selector to select the second power supply in the event that at least one of: the first power supply is incapable of supplying a power supply sufficient for at least part of the NFC communicator; and the second power supply provides a voltage higher than the first power supply.

An initiator near field RF communicator may transmit data or instructions by interrupting the RF field or modulating the RF field which may cause RF field amplitude changes. There may also be unintentional interruptions or reductions in the RF field due to, for example, environmental effects. Any such interruptions or reductions in the RF field may cause a reduction or ‘droop’ in the internal power supply of the inductively coupled responsive near field RF communicator.

Where there is a complete break in the supplied RF field, the magnetic field from which power is derived by the inductively coupled responsive near field RF communicator falls to zero and the responsive near field RF communicator may fail to respond. Where the RF field is weakened (for example during modulation), the available power supply may be insufficient to power the near field RF communicator and again any response may fail or be interrupted.

One way of addressing the effects on power derivation caused by a loss or weakening of the magnetic field may be to include a large capacitor to store power. However, such a capacitor would require a commensurately large amount of circuit area which would increase the overall size of the responsive near field RF communicator. Also, the introduction of additional capacitance may detrimentally affect, that is slow down, circuit response times.

In one aspect, the present invention provides a responsive near field RF communicator that overcomes, minimises or at least reduces the effect of a reduced RF field strength or break in a supplied RF field on at least one of its power derivation and operation without the need to include a large storage capacitor.

In one aspect, the present invention provides a near field RF communicator having a voltage regulator to control a voltage of a power supply and a regulator controller to control the voltage regulator in dependence upon a magnetic field of an RF field.

In one aspect, the present invention provides a responsive near field RF communicator wherein the regulator controller is operable to control a voltage regulator in dependence upon whether or not a magnetic field with which the near field RF communicator is inductively coupled is being modulated or interrupted, for example to enable transmission of data.

In one aspect, the present invention provides a near field RF communicator having an inductive coupler to enable inductive coupling with a magnetic field, a demodulator to extract modulation from an inductively coupled magnetic field, a voltage regulator to regulate a power supply voltage, and a regulator controller operable to control operation of the voltage regulator in dependence upon the magnetic field.

The RF communicator may comprise a power deriver to derive a power supply from an inductively coupled magnetic field.

In an embodiment the present invention provides a near field RF communicator having an inductive coupler (10) to enable inductive coupling with a magnetic field of an RF signal. A demodulator (102) extracts modulation from an inductively coupled magnetic field. A power provider (109) provides a first power supply for the communicator independent of any inductively coupled signal while a power deriver derives a second power supply from an RF signal inductively coupled to the antenna. A regulator (206; 1302) regulates a voltage supplied by at least one of the first and second power supplies on the basis of a comparison with a reference voltage. A modulator (M) is provided to modulate an inductively coupled magnetic field with data to be communicated via the inductive coupling. In an example, a regulator controller is provided to prevent operation of the regulator in the event of a magnetic field amplitude below a predetermined level or the presence of modulation.

Generally the voltage regulator comprises an error amplifier.

In an embodiment, the present invention provides a responsive near field RF communicator having an error amplifier to control a voltage within the near field RF communicator, for example within an antenna circuit of the near field RF communicator, and in which power supply to the error amplifier is controlled in accordance with signals dependent upon the strength of a magnetic field inductively coupled to the antenna and/or the presence of modulation.

In an embodiment, the present invention provides a near field RF communicator having a voltage-controlling error amplifier and in which power supply to the error amplifier is controlled in accordance with a signal received from at least one of a gap detector, a demodulator and a modulation indicator of the near field RF communicator.

In an embodiment, the present invention provides a near field RF communicator having a voltage-controlling error amplifier, and a switch for controlling supply of power to the error amplifier, the switch being operable in accordance with a signal received from at least one of a gap detector, a demodulator and a modulation indicator of the near field RF communicator.

In an embodiment, the present invention provides a near field RF communicator having an error amplifier to control a voltage of the communicator, a switch for controlling supply of power to the error amplifier and a further switch to control the output of said error amplifier, the switches being operable in accordance with a signal received from at least one of a gap detector, a demodulator and a modulation indicator of the near field RF communicator.

In an embodiment, the error amplifier controls the voltage between respective inputs of an antenna circuit of the near field RF communicator.

In an embodiment, the present invention provides an antenna apparatus suitable for use in a near field RF communicator, the antenna apparatus comprising an antenna circuit comprising an antenna coil and, in one example, at least one capacitor and at least two resistors, the apparatus further comprising an analogue interface coupled to the antenna circuit, the analogue interface comprising at least one error amplifier, at least one switch for controlling operation of the error amplifier, the switch being controlled by at least one of a demodulator, a gap detector and a modulation indicator, and a capacitor to store power derived from a supplied magnetic field. In one example, the switch is controlled so as not to provide power to the at least one error amplifier during at least one of modulation of the supplied magnetic field by the near field RF communicator and detection of any gap or reduction in level of supplied magnetic field.

The modulation indicator may be provided by a controller of the near field RF communicator.

An embodiment provides a near field RF communicator having: an inductive coupler to enable inductive coupling with a magnetic field of an RF signal; a demodulator to extract modulation from an inductively coupled magnetic field; an error amplifier operable to control a voltage of the near field RF communicator on the basis of a comparison of a reference voltage with a further voltage; a modulator operable to modulate an inductively coupled magnetic field with data to be communicated via the inductive coupling; and an error amplifier controller to inhibit operation of the error amplifier in the event of at least one of a magnetic field amplitude (or strength) below a predetermined level and the presence of modulation.

The near field RF communicator may comprise a power deriver to derive a power supply from an inductively coupled magnetic field said further voltage being related to a voltage derived by the power deriver.

The near field RF communicator may be a near field RF transponder or an NFC communicator

In an embodiment there is provided a near field RF communicator having an inductive coupler to enable inductive coupling with a magnetic field of an RF signal, a demodulator to extract modulation from an inductively coupled magnetic field, a voltage regulator to regulate a power supply voltage, and regulator controller to control operation of the voltage regulator in dependence upon the magnetic field.

An embodiment provides a near field RF communicator comprising a power deriver to derive a power supply from an inductively coupled magnetic field.

An embodiment comprises a modulator operable to modulate an inductively coupled RF field.

In an embodiment a near field RF communicator is provided wherein the regulator controller is operable to control the voltage regulator in dependence upon whether or not a RF field with which the near field RF communicator is inductively coupled is carrying data.

In an embodiment the regulator controller is operable to control operation of the voltage regulator in dependence upon at least one of the amplitude (or strength) of the magnetic field and the presence of modulation.

In an embodiment the regulator controller is operable to prevent operation of the voltage regulator in the event at least one of a magnetic field amplitude below a predetermined level and the presence of modulation.

In an embodiment the regulator controller comprises at least one of a gap detector to detect a break or interruption of an RF field and a modulation indicator to indicate the presence of modulation.

In an embodiment the voltage regulator comprises an error amplifier.

In an aspect there is provided a near field RF communicator having: an inductive coupler to enable inductive coupling with a magnetic field of an RF signal; a demodulator to extract modulation from an inductively coupled magnetic field; an error amplifier operable to control a voltage of the near field RF communicator on the basis of a comparison of a reference voltage with a further voltage; a modulator operable to modulate an inductively coupled magnetic field with data to be communicated via the inductive coupling; and an error amplifier controller to inhibit operation of the error amplifier in the event of at least one of a magnetic field amplitude (or strength) below a predetermined level and the presence of modulation.

In an embodiment a near field RF communicator comprises a power deriver to derive a power supply from an inductively coupled magnetic field said further voltage being related to a voltage derived by the power deriver.

In an embodiment the error amplifier controller comprises at least one of a modulation indicator to indicate modulation by the modulator and a gap detector to detect a gap or interruption in an inductively coupled magnetic field.

In an embodiment the error amplifier controller comprises a modulation indicator to indicate modulation by the modulator and a gap detector to detect a gap or interruption in an inductively coupled magnetic field, each coupled to control at least one switch to cause disconnection of the error amplifier in the event of an indication of modulation by the modulator or detection of a gap or interruption in an inductively coupled magnetic field.

In an embodiment the modulation indicator and gap detector are coupled to the at least one switch via an OR gate.

In an embodiment the modulation indicator comprises a controller of the near field RF communicator, the controller being operable to cause modulation of an inductively coupled magnetic field with data.

In an embodiment the modulator comprises a transistor element coupled in parallel across the inductive coupler and having a control gate controlled by the controller.

In an embodiment the error amplifier is operable to control an impedance coupled in parallel across the inductive coupler.

In an embodiment the impedance comprises a transistor element.

In an embodiment the transistor element comprises at least one MOSFET.

In an embodiment the near field RF communicator is one of a near field RF transponder and a near field RF communicator is an NFC communicator.

In an embodiment the near field RF communicator is operable for at least partial (or full) compliance under ISO/IEC 18092 and/or ISO/IEC 21481.

In an embodiment the near field RF communicator is provided within: a housing attachable to another device; a housing portion, such as fascia of another device; an access card; or a housing shaped or configured to look like a smart card.

In an embodiment the near field RF communicator comprises a responsive near field RF communicator.

In an embodiment there is provided an electrical device comprising a near field RF communicator.

In an embodiment the near field RF communicator is integrated within or dispersed within the functionality of the electrical device.

In an embodiment the near field RF communicator comprises at least one integrated circuit within the electrical device.

In an embodiment the device comprises at least one of a mobile telephone, a portable computing device such as a personal digital assistant, notebook, or lap-top, a personal or desk top computer, a computer peripheral such as a printer, or other electrical device such as a portable audio and/or video player.

In an embodiment there is provided a portable communications device incorporating a near field RF communicator.

In a aspect there is provided a NFC communicator comprising: an antenna to inductively couple to the H field of an RF signal; a power provider to provide a first power supply for the NFC communicator independent of any inductively coupled signal; a power deriver to derive a second power supply for the NFC communicator from an RF signal inductively coupled to the antenna; and a regulator to regulate a voltage supplied by at least one of the first and second power supplies.

In an embodiment there is provided an NFC communicator comprising a selector to select the second power supply in the event that at least one of: the first power supply is incapable of supplying a power supply sufficient for at least part of the NFC communicator; and the second power supply provides a voltage higher than the first power supply.

In an embodiment the voltage regulator comprises a shunt impedance.

In an embodiment the voltage regulator comprises an error amplifier to compare a voltage of the at least one of the first and second power supplies with a reference voltage.

In an embodiment the voltage regulator comprises an error amplifier coupled to compare a voltage of the at least one of the first and second power supplies with a reference voltage and a shunt impedance having an impedance controllable by an output of the error amplifier.

In an embodiment the voltage regulator comprises an error amplifier having a first input coupled to a supply voltage output of the selector, a second input coupled to a reference voltage source and an output, and a transistor having first and second main electrodes providing a shunt current path and a control electrode coupled to the output of the error amplifier to control the impedance of the shunt current path.

In an embodiment the reference voltage is at or below the maximum voltage which can be tolerated by the functional components of the NFC communicator.

In an embodiment the selector is operable to select the one of the first and second power supplies providing the highest voltage.

In an embodiment the power deriver comprises a rectifier to provide a rectified voltage from the H field of an RF signal inductively coupled to the antenna.

In an embodiment the rectifier comprises a diode rectifier.

In an embodiment the diode rectifier comprises at least one of: one or more diodes; and one or more diode-coupled transistors.

In an embodiment the rectifier is provided by a circuit which also provides the voltage regulator.

In an embodiment the selector is operable to couple the selected power supply to power at least some of the operational components of the NFC communicator.

In an embodiment the selector is operable to couple the selected power supply to power only some of the operational components of the NFC communicator when the selected power supply is the second power supply.

In an embodiment the operational components include components providing at least the ability of the NFC communicator to respond to another near field RF communicator.

In an embodiment the power provider comprises or is coupled to a power supply comprising at least one of a battery and a fuel cell.

In an embodiment there is provided an NFC communicator having at least one of: a demodulator to extract modulation from an inductively coupled magnetic field; and a modulator to modulate an inductively coupled magnetic field with data to be communicated via inductive coupling.

### BRIEF DESCRIPTION OF THE DRAWINGS

Embodiments of the present invention will now be described, by way of examples, with reference to the accompanying drawings, in which:

FIG. 1 shows a functional block diagram of one example of a near field RF communications-enabled device comprising a near field RF communicator embodying the invention;

FIG. 2 shows a functional block diagram of a near field RF communications-enabled device embodying the invention illustrating ways in which various functional components of the near field RF communicator including an analogue interface may be implemented; and

FIG. 3 shows a functional block diagram of another example of a near field RF communications-enabled device comprising a near field RF communicator embodying the invention;

FIG. 4 shows a functional block diagram of another example of a near field RF communications-enabled device embodying the invention; and

FIG. 5 shows a diagram to illustrate a regulator circuit that may be used in the near field RF communications-enabled device shown in FIG. 4.

### DETAILED DESCRIPTION OF THE EMBODIMENTS

With reference to the drawings in general, it should be understood that any functional block diagrams are intended simply to show the functionality that exists within the device and should not be taken to imply that each block shown in the functional block diagram is necessarily a discrete or separate entity. The functionality provided by a block may be discrete or may be dispersed throughout the device or throughout a part of the device. In addition, the functionality may incorporate, where appropriate, hard-wired elements, software elements or firmware elements or any combination of these. The near field RF communicator may be provided wholly or partially as an integrated circuit or collections of integrated circuits.

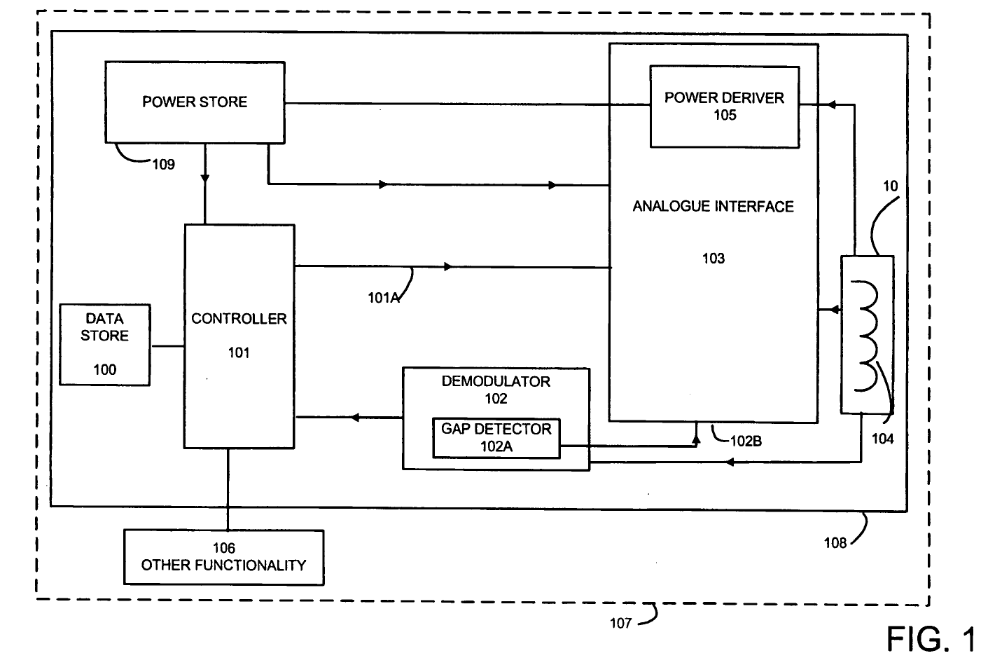

Referring now to FIG. 1, there is shown a functional block diagram of one example of a near field RF communicator in accordance with the invention.

In this example the near field RF communicator comprises a near field RF transponder 108.

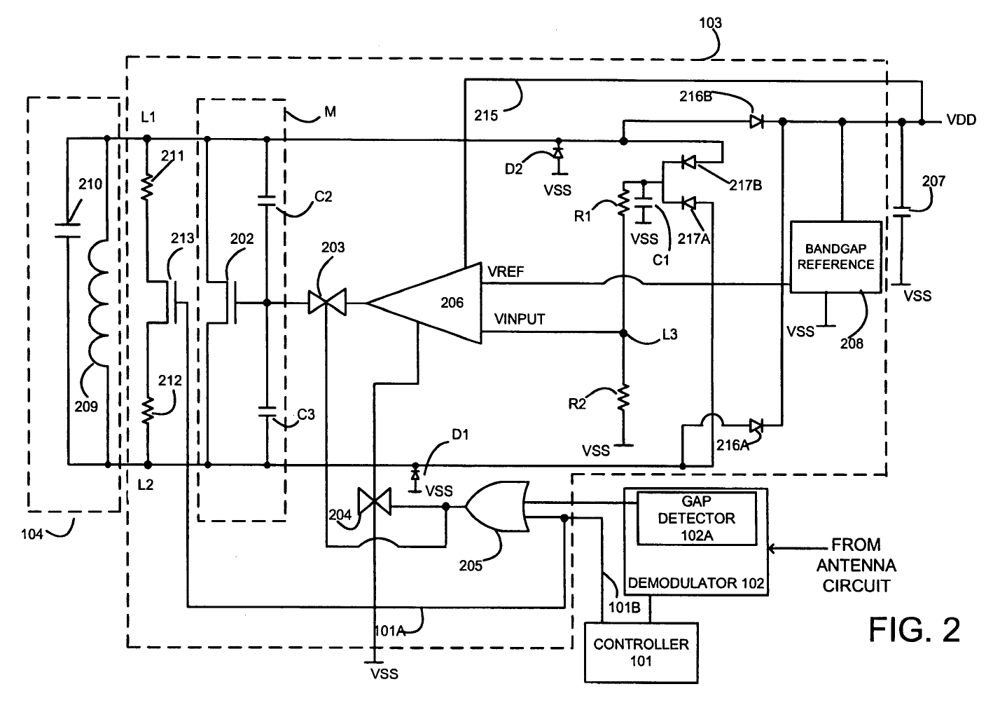

The near field RF transponder 108 has an inductive coupler or antenna circuit 10 and an analogue interface 103 to provide an interface between the antenna circuit and other operational components of the near field RF transponder 108. As FIG. 1 is a functional block diagram, the antenna circuit 10 is shown simply by a representation of an antenna coil 104. Any suitable form of series or parallel antenna circuit may be used and one example will be described below with reference to FIG. 2. The antenna circuit 10 enables inductive coupling to an alternating magnetic field (H field) of an RF signal (for example a 13.56 Mega Hertz signal) generated or transmitted by, for example, an initiator near field RF communicator such as an RFID transceiver or an NFC communicator in initiator mode.

As shown in FIG. 1, the other operational components comprise a demodulator 102 coupled to the antenna circuit 10 to extract the modulation (data) from a modulated magnetic field inductively coupled to the antenna circuit 10. The demodulator 102 is also coupled to supply the extracted data to a controller 101 that controls overall operation of the near field RF transponder 108. A data store 100 is coupled to the controller 101.

The near field RF transponder 108 has a power deriver 105 coupled to the antenna circuit 10 to derive at least a portion of a power supply for the near field RF transponder 108 from an inductively coupled alternating magnetic field and a power store 109 coupled to store power derived by the power deriver 105. The power store 109 may be a capacitor, or a number of capacitors. Although the power deriver 105 is shown in FIG. 1 as being within the analogue interface 103, it may be separate from the analogue interface 103.

The power store 109 is coupled to provide power for those components of the near field RF transponder 108 that require power. However, in the interests of clarity in FIG. 1, not all of the couplings to the power store 109 are shown in FIG. 1.

As shown in FIG. 1, the near field RF transponder 108 is also coupled via the controller 101 to other functionality 106. The other functionality 106 may comprise, for example, any one or more of a further data store, a user interface, an audio output or a display screen of the near field RF communicator.

As described so far the near field RF transponder 108 is a standalone device. However, as another possibility, the near field RF transponder 108 may form part of another electrical device or host 107. In this case, the other functionality 106 will be the functionality of that other electrical device or host 107 and its precise nature will depend upon the particular electrical device or host. Accordingly, for simplicity, the other functionality 106 of the remainder of the near field RF communications-enabled device is not shown in detail in FIG. 1.

As another possibility, the other functionality 106 may be an interface to another electrical device or host with which the near field RF transponder 108 may be associated to form a near field RF communications-enabled device. In this case, the near field RF transponder 108 may be associated with the host by, for example, a wired or wireless coupling. In such a case, a housing of the near field RF transponder 108 may be physically separate from or may be attached to the housing of the host; in the later case, the attachment may be permanent once made or the near field RF transponder 108 may be removable. As examples, the near field RF transponder 108 may be housed within: a housing attachable to another device; a housing portion, such as a fascia of the near field RF communications-enabled device or another device; an access card; a key fob; a token; or may have a housing shaped or configured to look like a smart card. As other examples, the near field RF transponder 108 may be coupled to a larger device by way of a communications link such as, for example, a USB link, or may be provided as a card (for example a PCMCIA card or a card that looks like a smart card) which can be received in an appropriate slot of the larger or host device.

Examples of hosts are, for example, personal computers, mobile telephones (cell-phones), personal digital assistants, notebooks, other computing devices such as personal or desk top computers, computer peripherals such as printers, or other electrical devices such as portable audio and/or video players such as MP3 players, IPODs®, CD players, DVD players, other electrical or electronic products, for example consumer products such as domestic appliance or personal care products, and other electrical or electronic devices, apparatus or systems.

The controller 101 is provided to control overall operation of the near field RF transponder 108, for example to control when and how data is communicated from the near field RF transponder 108. The data store 100 is arranged to store data (information and/or control data) to be communicated from and/or data received by the near field RF transponder 108. The controller 101 may be a microprocessor, for example a RISC processor or other microprocessor or a state machine. Program instructions for programming the controller 101 and/or control data for communication to another near field RF communicator may be stored in an internal memory of the controller and/or the data store 100 and/or other the functionality 106 which may, as indicated above, be provided within, a host.

The controller 101 and the demodulator 102 are coupled to the analogue interface 103. As will be described below, the analogue interface includes a modulation element to enable the controller to modulate a received magnetic field with data and a voltage regulator to enable control of the supply of power within the near field RF transponder in accordance with the received magnetic field strength (amplitude) which, as will be described below with reference to FIG. 2, may be affected by environment factors and also by interruption or modulation to enable transmission of data. To this end, the demodulator 102 comprises, in addition to demodulator circuitry (not separately shown) to extract the modulation from the carrier signal, a gap detector 102A or similar functionality for detecting gaps in the received RF field or reductions in the strength of the RF field as a result, for example, of amplitude modulation or environmental conditions. The demodulator circuitry may comprise any suitable form of demodulator, for example a simple diode rectifier circuit, for extracting the modulation from an RF carrier signal. The gap detector 102A may comprise, for example, filtering and rectifying circuitry to extract and rectify the carrier signal and threshold circuitry for providing a gap detection signal when the rectified carrier signal is below a predetermined threshold value. As another possibility, peak detector circuitry may be used to detect when a peak value of the carrier signal falls below a predetermined threshold. It will, however, be appreciated that the gap detector may comprise any circuitry suitable to detect the absence of the carrier signal or a reduction in the amplitude of the carrier signal below a predetermined threshold. Although shown as part of the demodulator 102, the gap detector 102A may be a functional block that is separate from the demodulator.

In operation of the near field RF transponder 108 shown in FIG. 1, the power deriver 105 of the near field RF transponder 108 derives a power supply from a magnetic field inductively coupled to the antenna circuit 10 and provided by, for example, an initiator near field RF communicator (such as a near field RF transceiver or initiator mode NFC communicator) within near field range. Once the power store 109 of the near field RF transponder 108 stores sufficient power, the demodulator 102 extracts any modulation from the inductively coupled magnetic field and supplies this to the controller 101 for further processing.

The controller 101 controls communication of data by the near field RF transponder 108 in accordance with at least one of pre-stored instructions or programming and instructions determined by the controller from modulation extracted by the demodulator 102. The controller 101 causes data to be communicated by controlling the modulation element mentioned above to modulate the load (“load modulation”) on the inductive coupling between the near field RF transponder and the initiator near field RF communicator. The modulation element may comprise a transistor element in parallel with the antenna coil of the antenna circuit 104. The controller supplies a modulation signal representing the data to be communicated to a control gate of the transistor element, thereby causing an impedance to be switched across the antenna coil of the antenna circuit 104 in accordance with the data to be communicated. The load on the inductive coupling between the antenna circuit 104 of the near field RF transponder and the initiator near field RF communicator is thus varied in accordance with the data to be communicated, so causing modulation of the amplitude of the signal in the antenna circuit of the initiator near field RF communicator, which modulation can then be extracted by a demodulator of the initiator near field RF communicator. The modulation scheme used will depend on the communications protocol being used and program data within controller 101. For example such modulation scheme may be compatible with ISO 14443A and thus enable the near field RF transponder in FIG. 1 to communicate with ISO 14443A compatible initiator near field RF communicators.

FIG. 2 shows a functional block diagram to illustrate ways in which various components of a near field RF transponder (for example 108 from FIG. 1) embodying the invention may be implemented.

In this example, the antenna circuit 104 comprises an antenna coil 209 coupled in parallel with a capacitor 210. The actual detailed configuration of the antenna circuit 104 will depend upon the precise antenna coil design and filtering requirements. For example, a number of filtering capacitors (not shown) may be included in the antenna circuit 104.

In this example, the power deriver 105 (from FIG. 1) comprises a full wave rectifier comprising diodes 216A and 216B having their cathodes coupled to a first power supply line VDD and diodes 217A and 217B having their cathodes coupled to a second or ground power supply line VSS via a capacitor C1 in parallel with series-connected resistors R1 and R2. A junction between diodes 217B and 216B is coupled to the second power supply line VSS by a diode D2.

In this example, the power store 109 (from FIG. 1) comprises a capacitor 207 coupled between the first power supply line VDD and the second power supply line VSS. For convenience not all of the couplings of the various components of the near field RF transponder between the first and second power supply lines VDD and VSS are shown.

As discussed above, the analogue interface 103 comprises a switchable impedance element M coupled between respective connection junctions L1 and L2 of the antenna coil 209. In order to communicate data, the controller 101 switches the switchable impedance element M in and out in accordance with the data to be communicated, thereby modulating the load on the inductively coupled antenna circuits of the near field RF transponder (for example 108 from FIG. 1) and the initiator near field RF communicator. In the example shown, the switchable impedance element M comprises a transistor element consisting of one or more transistors 213 (as shown an n-channel enhancement mode MOSFET) having a control gate coupled to a data output or modulation signal line 101A of the controller 101. Optionally the switchable impedance element M also comprises a resistor 211 coupling one main electrode of the transistor element 213 to junction L1 and a resistor 212 coupling the other main electrode of the transistor element 213 to junction L2.

The voltage between junctions L1 and L2 is controlled by an error amplifier 206 powered by a direct coupling to the power supply line VDD and a coupling to the power supply line VSS via a switch 204 (which may be a MOS transistor for example). One input of the error amplifier is coupled to a reference voltage (shown as VREF in FIG. 2). As shown, VREF is derived from a band gap reference circuit 208. As another possibility, a Zener diode may for example be used to define VREF. The other input of the error amplifier is coupled to a junction L3 between the resistors R1 and R2 which form a voltage divider providing a voltage VINPUT at junction L3 so that the voltage VINPUT is related to the voltage between L1 and L2. The output of the error amplifier 206 is coupled via switch 203 (which may be a MOS transistor for example) to the control gate of a shunt transistor element 202 (again in this example an n-channel enhancement mode MOSFET) having its control gate coupled to L1 via capacitor C2 and coupled to L2 via capacitor C3.

Although not shown in FIG. 2, as will be understood by the person skilled in the art, the demodulator 102 is coupled to the antenna circuit 104 to enable the demodulator 102 to extract data from an RF signal inductively coupled to antenna circuit from an initiator near field RF communicator. Such an initiator near field RF communicator may cause the RF signal to be interrupted in accordance with the data to be transmitted or to be modulated, for example, amplitude modulated, in accordance with the data to be transmitted. The controller 101 may respond by communicating data using load modulation as discussed above. So as to avoid conflict, the controller 101 may disable the demodulator 102 whilst the controller 101 is communicating data.

The controller 101 also provides a modulation indicator output 101B which is high when the controller is supplying data to the modulation element M. The modulation indicator output 101B is coupled to one input of an OR gate 205. The other input of the OR gate 205 is coupled to an output of the gap detector 102A. The output of the OR gate 205 is coupled to control operation of the switches 203 and 204.

In operation, the input to the OR gate 205 from the gap detector 102A is low when there is no gap or the magnetic field amplitude is above the predetermined threshold. Similarly, the input to the OR gate 205 from the controller 101 is low when the controller 101 is not providing data to modulate the RF field. However, when the gap detector 102A detects a gap in the magnetic field or a reduction in its amplitude below a predetermined threshold as described above, then the input to the OR gate 205 from the gap detector 102A goes high. Similarly when the controller 101 is outputting data to modulate the RF field, then the input to the OR gate 205 from the controller 101 goes high. When the inputs from the gap detector and the controller 101 (acting as a modulation indicator) are both low, then the output of the OR gate will be low and the switches 203 and 204 will be closed or conducting, so coupling power to the error amplifier 206 and coupling the output of the error amplifier 206 to the shunt transistor element 202 to enable the error amplifier 206 to control the impedance provided by the shunt transistor element 202 and so to regulate the voltage between junctions L1 and L2 in accordance with VREF. If, however, the input from the gap detector and/or the input from the controller 101 (acting as a modulation indicator) goes high, then the output of the OR gate 205 will go high and the switches 203 and 204 will be opened or rendered non-conducting (their bias currents are turned off), so disconnecting power from the error amplifier 206 and disconnecting the output of the error amplifier 206 to the shunt transistor element 202. A pair of capacitors C2 and C3 are arranged for stabilization of the control loop.

Thus, when a signal is received from either the gap detector (equating to a gap or reduction in the magnetic field strength coupled to antenna coil 209) or the controller (equating to modulation by the controller of the received magnetic field), the output from the OR gate 205 turns off switch 204 (its bias current is turned off). This has the effect of disrupting the supply of power to the error amplifier 206 and thereby reducing the overall power required by the near field RF transponder. Also turning off switch 203 prevents the error amplifier 206 from having any effect on the voltage between junctions L1 and L2. The switches 203 and 204 and the controller 101 and gap detector 102A also function to ensure that the error amplifier 206 does not regulate the voltage between L1 and L2 while modulation is occurring. This prevents the error amplifier 206 from changing the modulation level or depth and so avoids the possibility of the modulation being distorted by the error amplifier 206 which might otherwise result in the modulation being very difficult or impossible to extract.

By controlling the power usage of the near field RF transponder, the effect of any droop or gap in the received magnetic field can be minimized. As a result the drain on the capacitor 207 when the strength of received inductively coupled RF field is reduced or the RF field is interrupted is reduced, thereby enabling the size of the capacitor 207 to be reduced, potentially reducing circuit size and circuit cost.

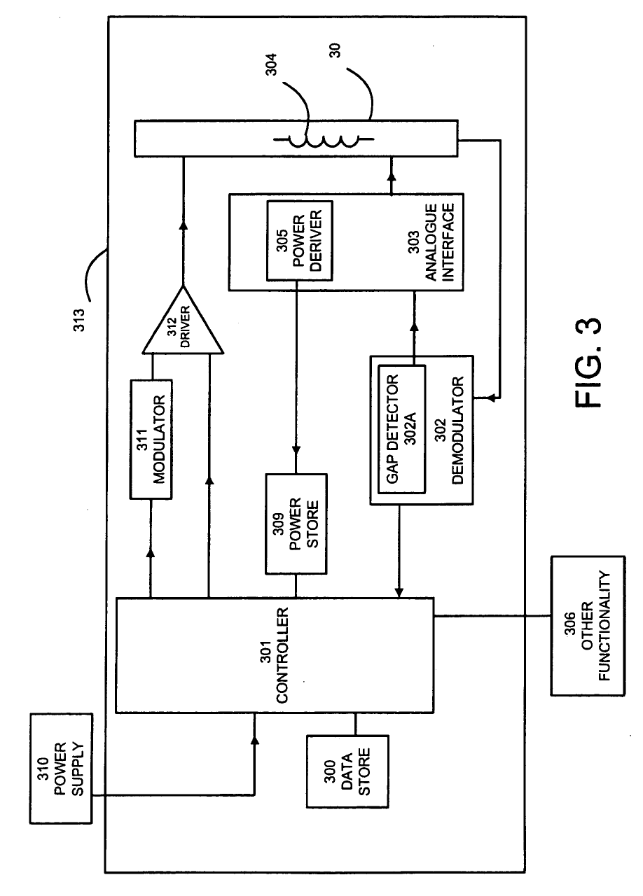

FIG. 3 shows a second near field RF communicator in accordance with the invention.

In FIG. 3 the near field RF communicator is an NFC communicator 313, for example an NFC communicator compatible with either ISO/IEC 21481 or ISO/IEC 18092.

The NFC communicator 313 has an inductive coupler or antenna circuit 30 and an analogue interface 303 to provide an interface between the antenna circuit 30 and other operational components of the NFC communicator 313. As FIG. 3 is a functional block diagram the antenna circuit 30 is shown simply by a representation of an antenna coil 304. Any suitable form of series or parallel antenna circuit may be used. The antenna circuit 30 enables inductive coupling to an alternating magnetic field (H field) (for example from a 13.56 Mega Hertz signal) generated or transmitted by, for example, an initiator near field RF communicator such as an RFID transceiver or an NFC communicator in initiator mode.

As shown in FIG. 3, the other operational components comprise a demodulator 302 coupled to the antenna circuit 30 to extract the modulation from a modulated signal inductively coupled to the antenna circuit 30. The demodulator 302 is also coupled to a controller 301 provided to control overall operation of the NFC communicator 313. A data store 300 is coupled to the controller 301.

The NFC communicator 313 has a power deriver 305 coupled to the antenna circuit 30 to derive at least a portion of a power supply for the NFC communicator 313 from an inductively coupled alternating magnetic field and a power store 309 to store power derived by the power deriver 305. The power store may be a capacitor, or a number of capacitors. Although the power deriver 305 is shown in FIG. 3 as being within the analogue interface 303, it may be separate from the analogue interface 303.

In the interests of clarity in FIG. 3, not all of the couplings to the power store 309 are shown in FIG. 3.

The demodulator 302 comprises a gap detector 302A or similar functionality for detecting gaps or reductions (for example resulting from amplitude modulation) in the received RF field, thus indicating the presence of a change in received RF field and potential modulation. Although the gap detector is shown as part of the demodulator, it may be separate. The NFC communicator may also comprise a magnetic field detector for detecting the presence of an inductively coupled magnetic field. The magnetic field detector may, for example, be used as part of a wake up mechanism for the device or to check that another device is not already transmitting a magnetic field.

The functionality of the NFC communicator described so far is similar to that of the RF transponder discussed above and the antenna circuit 30, analogue interface 103, power deriver 305 and gap detector 302A may be of the form shown in FIG. 2.

In addition, however, the NFC communicator 313 also has the ability to generate or transmit its own RF field and also to modulate that RF field. In the example shown, this functionality consists of a driver 312 having an output coupled to the antenna circuit 30, one input coupled to the controller 301 and the other input coupled to a modulator 311 coupled to the controller. The NFC communicator 313 also has a power supply 310 which may be part of the NFC communicator or the other functionality, for example the power supply 310 may be provided by a host or. The power supply 310 may be, for example, a battery such as a button cell battery.

As shown in FIG. 3, the NFC communicator 313 is also coupled via the controller 301 to other functionality 306. The other functionality 306 may comprise, for example, any one or more of a further data store, a user interface, an audio output or a display screen of the near field RF communicator.

As another possibility, the NFC communicator 313 may form part of another electrical device or host in which case the other functionality 306 will be the functionality of that other electrical device or host.

As another possibility, the other functionality 306 may be an interface to another electrical device or host with which the NFC communicator 313 may be associated to form a near field RF communications-enabled device. The NFC communicator 313 may be associated with the host, for example by a wired or wireless coupling examples being as described above with reference to FIG. 1. As another possibility, the other functionality 306 may include, for example, an interface to another electrical device thereby forming a near field RF communications-enabled device. For convenience, the functionality of the remainder of the near field RF communications-enabled device is not shown in FIG. 3. Examples of such host devices may be the same as for the examples given above for FIG. 1.

The controller 301 controls when and how data is communicated from the NFC communicator. As above, the controller 301 may be a microprocessor, for example a RISC processor or other microprocessor or a state machine. Program instructions for programming the controller and/or control data for communication to another near field RF communicator may be stored in an internal memory of the controller and/or the data store 300 and/or other functionality (306) within, for example, a near field communications-enabled device.

An NFC communicator 313 is capable of operating in an initiator or a target mode. The mode may be determined by the controller 301 or may be determined in dependence on the nature of a received near field RF signal. The functionality required to enable the NFC communicator 313 to operate in target mode is similar to that described above with reference to FIG. 1.

In the initiator mode, the NFC communicator 313 may initiate communication with any compatible target which may be an NFC communicator 313 in target mode or a near field RF transponder of FIGS. 1 and 2 such as shown in FIGS. 1 and 2. In the target mode, the NFC communicator 313 may respond to initiation of communication by any compatible initiator which may be an RFID transceiver or an NFC communicator in initiator mode. As used herein, compatible means operable at the same frequency and in accordance with the same protocols, for example in accordance with the protocols set out in various standards such as ISO/IEC 18092, ISO/IEC 21481, ISO/IEC 14443 and ISO/IEC 15693. Communication may be an active communication under which the initiator and target each generate their own RF field when communicating data and then turn off that RF field to await data communication from the other or passive communication under which the initiator transmits and maintains its RF field throughout the entire communication.

Communication of data by the NFC communicator will depend on the operational mode of the device i.e. whether the device is in initiator or target mode, whether the device is using active or passive communication and the communications protocol in accordance with which data is being communicated.

Where the NFC communicator is in initiator mode and using active communication, the driver 312 is controlled by the controller 301 to drive the antenna circuit to produce the required RF field and the modulator 311 is controlled by the controller 301 to cause the RF field to be modulated in accordance with the data (information and/or control data) to be communicated. The controller 301 may use its own internal clock as an oscillator from which to derive the oscillating signal to produce the RF field or a separate oscillator may be provided either within the NFC communicator 313 or its host, if it has one.

Where the NFC communicator is in target mode, then the operation of the NFC communicator will be similar to that described above for the near field RF transponder. For example, when the NFC communicator is in target mode and uses the circuitry shown in FIG. 2, then, as described above with respect to FIG. 2, the voltage between L1 and L2 is controlled by the error amplifier 206 and operation of the error amplifier is in turned controlled by the switches 203 and 204. Where the NFC communicator is independently powered (i.e. the power supply 310 is available), the error amplifier 206 may or may not be powered down in the event that the external magnetic field droops. Operation of the error amplifier may be controlled entirely by controller 301, that is only in circumstances where the NFC communicator is modulating a supplied RF field with data. The error amplifier 206 will be disconnected by the controller when the NFC communicator is providing its own RF field. As another possibility, the switches 203 and 204 (FIG. 2) may be controlled by a signal from the modulator 311 rather than the controller 301, so that the error amplifier is only disconnected while the modulator is modulating the NFC communicator's own RF field. Even where the additional power supply 310 is available, the ability to re-direct power away from specific areas of the antenna circuitry (namely the error amplifier 206) may still be advantageous, for example where the additional power supply 310 is low or has been disconnected.

As will be appreciated from the above, the controller of a near field RF communicator or near field RF communications-enabled device embodying the invention is operable to control the near field RF communications process to, for example, ensure that the near field RF communicator operates in compliance with the appropriate communications protocol(s) and to control the timing (using its own clock where appropriate), manner and mode of operation of the near field RF communicator. The controller 301 is also operable to control communication with any host device, where required.

The functionality of the controller is described above as being entirely within the near field RF transponder or NFC communicator. As other possibilities, the functionality of the controller may be entirely within any host device controller or distributed between the near field RF transponder or NFC communicator and the host device. As a further possibility for an NFC communicator, certain control functionality may reside within a separate unit which is attachable or removable or alternatively only used for certain transactions, for example a security device or ESD device which may only be used for payment transactions. Where the functionality of the controller is within a separate unit or within any host device, then instead of the controller the near field RF transponder or NFC communicator will have a coupling, possibly including an appropriate interface, to that controller.

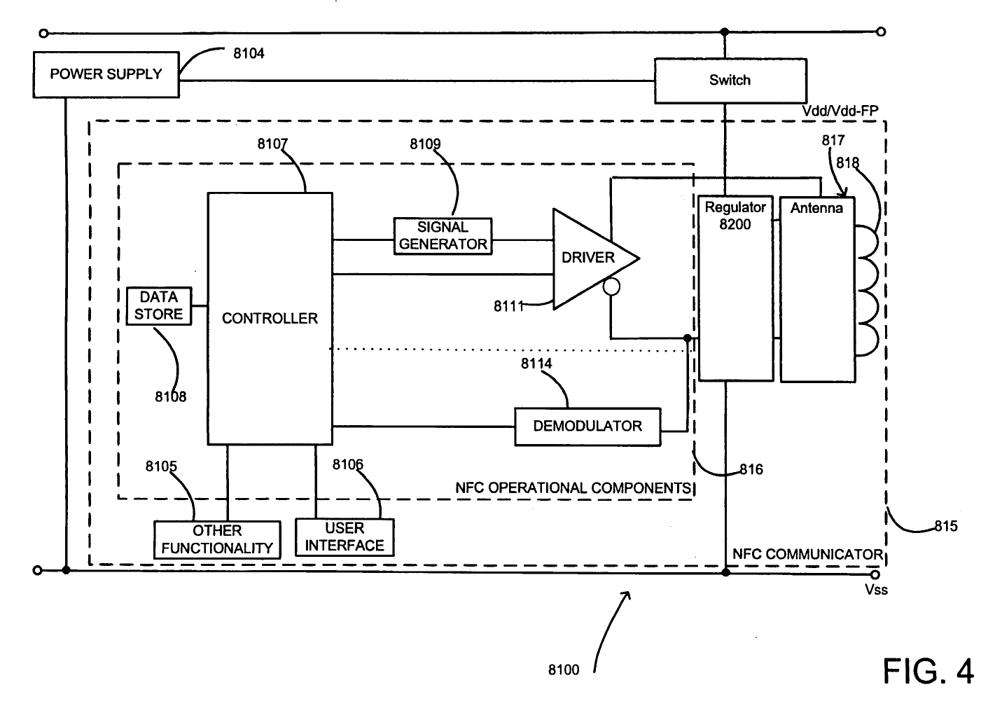

FIG. 4 shows a functional block diagram of another NFC communications enabled device 8100 in accordance with the invention.

In this example, the NFC communications enabled device 8100 comprises an NFC communicator 815 having NFC operational components 816 including an antenna circuit 817, controller 8107, data store 8108, signal generator 8109 and demodulator 8114.

The NFC communications enabled device 8100 may or may not also have or be capable of being connected or coupled with at least one of other functionality 8105 (for example functionality of a host device such as described above) and a user interface 8106.

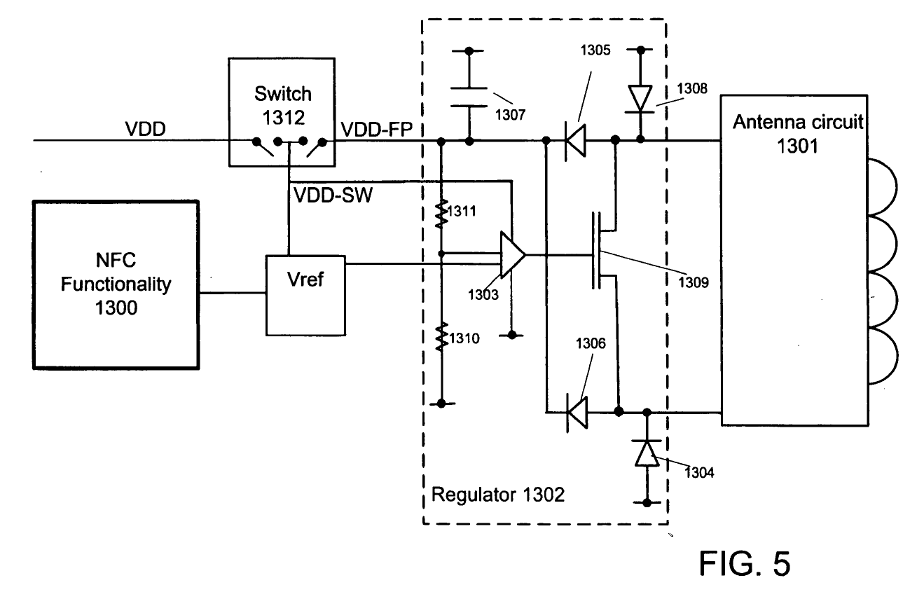

Power is provided via either of the power supply rails labeled VDD and VDD-FP. In the interests of simplicity, power supply couplings to specific components within the NFC communicator are not shown in FIG. 4. In FIG. 4 the power may be derived in one of two ways. First the power may be derived as described above from a battery or dedicated power supply 8104 (whether specific to the NFC communicator 815 or provided by the other functionality 8105). This is referred to as VDD below. Second a power supply can be obtained via regulator circuit 8200 through the rectification of the voltage coupled to antenna circuit 817 when NFC communicator 815 receives a magnetic field. This is referred to as VDD-FP below. The power supply used by the NFC communicator is determined by a switch (labeled “switch” in FIG. 4 and described in more detail with reference to FIG. 5 below).

Regulator circuit 8200 operates to protect components of the NFC communicator from damage caused by receipt of a high field strength. The regulator circuit 8200 operates where power supply is derived from a supplied magnetic field (referred to as VDD-FP in FIGS. 4 and 5) in which case it protects the NFC circuit components against high field strengths and provides a rectified power supply to the NFC communicator.

The NFC operational components include a demodulator and amplifier 8114 coupled between the antenna circuit 817 and the controller 8107 for amplifying and demodulating a modulated RF signal inductively coupled to the antenna circuit 817 from another near field RF communicator in near field range and for supplying the extracted data to the controller 8107 for processing.

In addition the NFC operational components include components for enabling modulation of an RF signal to enable data to be communicated to another near field RF communicator in near field range of the NFC communicator 815. As shown in FIG. 4, these components comprise a signal generator 8109 coupled via a driver 8111 to the antenna circuit 817. In this example, the signal generator 8109 causes modulation by gating or switching on and off the RF signal in accordance with the data to be communicated. The NFC communicator may use any appropriate modulation scheme that is in accordance with the standards and/or protocols under which the NFC communicator operates. Alternatively a separate or further signal controller may be incorporated within the NFC operational components to control modulation of the signal generated by the signal generator 8109 in accordance with data or instructions received from the controller 8107.

The NFC operational components also include a controller 8107 for controlling overall operation of the NFC communicator. The controller 8107 is coupled to a data store 8108 for storing data (information and/or control data) to be transmitted from and/or data received by the NFC communications enabled device. The controller 8107 may be a microprocessor, for example a RISC processor or other microprocessor or a state machine. Program instructions for programming the controller and/or control data for communication to another near field RF communicator may be stored in an internal memory of the controller and/or the data store.

FIG. 5 shows a diagram to illustrate in detail one example of a regulator circuit 1302.

In FIG. 5 the regulator circuit 1302 is connected in between the antenna circuit 1301 (817 in FIG. 4) and the NFC operational components (1300 in FIGS. 5 and 816 in FIG. 4). The antenna circuit 1301 may be any antenna circuit suitable for use in an NFC communicator. For example the antenna circuit may comprise a coil and a series of capacitors. When a magnetic field is coupled to antenna circuit 1301 such field is coupled to regulator 1302. In the interests of clarity, not all coupling to power supply rails are shown in FIG. 5.

The regulator 1302 protects the NFC circuit from over-voltage conditions even when the NFC circuit has no internal power supply VDD. Such protection is required because IC components of an NFC have a maximum safe operating voltage, above which they may be damaged or destroyed. Such over-voltage conditions can occur when the antenna is exposed to a high magnetic fields RF signal.

A signal provided by the antenna circuit 1301 is rectified by means of a rectifier comprising, in the example shown, diodes 1304, 1305, 1306, 1308 to provide VDD-FP.

An error amplifier 1303 has one input which receives a reference voltage Vref and another input which is coupled to the junction between resistors 1311 and 1310 of a resistor network in which resistor 1311 is coupled to VDD-FP and resistor 1310 to ground. A capacitor 307 provides energy storage and the current required by the rest of the regulator circuit 302. Resistors 311 and 310 provide scaling for the regulator circuit. For example where Vref is 1.2V and the VDD limit is 3.3V, the resistors will scale the voltage seen at the error amplifier 303 from 3.3V to 1.2V i.e. to scale by 0.363 (1.2/3.3).

The output of the error amplifier 1303 is coupled to the control gate of a shunt element 1309, as shown a NMOSFET, although any suitable controllable shunt element may be used.

The regulator 1302 is thus a shunt regulator which operates by sensing the voltage at VDD-FP, via resistors, 1310, 1311, and generating an error signal which is related to the difference between VDD-FP (scaled by the resistor network 1310, 1311) and the reference voltage Vref. The error signal is then used to control the shunt element 1309 so that the voltage at VDD-FP does not rise above a limit determined by the value of Vref and the resistor ratio.

In this example, the shunt regulator is able to operate when an internal supply VDD (from a battery of the NFC communicator or its host, for example) may or may not be available.

In order to be able to operate when the internal supply VDD is either available or not available, the error amplifier 1303 and reference supply circuit need to be powered from whichever supply, VDD or VDD-FP, is higher. This function is fulfilled by a switch 1312 which provides an output VDD-SW representing the higher of VDD or VDD-FP.

The switch 1312 may, for example, comprise a comparator to sense which of its inputs (VDD, VDD-FP) is higher, and a multiplexer which connects the output VDD-SW to the higher of VDD and VDD-FP.

As will be clear to those skilled in the art the principle of employing a voltage regulator to regulate the voltage provided to components of an NFC communicator may be used where appropriate in any of the above described embodiments and examples of the invention.

The power supply provided by regulator circuit 1302 is supplied to NFC functionality 300 (connections not shown in detail) via switch 1312. Although FIG. 5 shows a single coupling from the switch 1312 to the NFC functionality 1300, the power coupling to the NFC functionality 1300 may be such that, when the NFC communicator is relying on the power supply provided by VDD-FP derived from a received magnetic field, for example because the battery is dead or disconnected, that power may only be supplied or used for a restricted set of NFC functionality. For example power may only be used by NFC functionality 300 to enable the corresponding NFC communicator to operate in passive communication mode and to respond to a modulated signal received from another near field RF communicator, that is in some examples the power supply may not be used to enable generation of a signal by the NFC communicator or to power other functionality (shown as 105 in FIG. 2).

It will be appreciated that such a switch may be incorporated in the examples described above with reference to FIGS. 2 and 3.

It will also be appreciated that any appropriate antenna driving method may be use and that the driving methods represented by FIGS. 2, 3 and 4 are simply examples.

The error amplifier may in some circumstances only operate when the power supply is being derived from a magnetic field.

As described above, the data store comprises a memory within the near field RF transponder or NFC communicator. As another possibility, the data store may be comprised within any host device or shared or co-located memory device or data storage means. For example the data store may reside within the host device and all data may be centrally held within such host device. Alternatively data may be stored both within the near field RF transponder or NFC communicator (for example data relevant to operation of the near field RF transponder or NFC communicator) and within a memory (not shown) within the host device (for example data relevant to the operation characteristics of the host device). The data store may be read only or may be read/write, depending upon whether data is to be written to as well as read from the data store.

As described above, the functional block diagrams shown in FIGS. 1, 2, 3, 4 and 5 would apply equally to a standalone near field RF communicator, in which case the other functionality 106 and 306 may be omitted.

FIG. 2 shows various components which may have a particular polarity or type. Where this is the case then components of the other type or polarity may be used with appropriate circuit modification, for example p-channel devices may be used in place of n-channel devices and/or depletion mode devices may be used instead of enhancement mode devices, with appropriate circuit modification. Also, it may be possible to use other forms of semiconductor devices controlled by a control gate (such as bipolar transistors or JFETS) in place of the MOSFETs described above. The diodes described above may be for example diode-connected MOSFETs.

The components of the near field RF communicators described above, apart from the power supply, if present, and the antenna circuit may be provided by a single semiconductor integrated circuit chip or by several separate chips, for example one or more silicon integrated circuits, or discrete devices mounted on a printed circuit board. Whether particular functions are implemented by analogue or digital circuitry will depend on the design route chosen. Antennas will be constructed in a form suitable for system and circuit requirements and may, as described above be coils.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention.

1. A near field RF communicator having an inductive coupler to enable inductive coupling with a magnetic field of an RF signal, a demodulator to extract modulation from an inductively coupled magnetic field, a voltage regulator to regulate a power supply voltage, and regulator controller to control operation of the voltage regulator in dependence upon the magnetic field.

2. A near field RF communicator according to claim 1 comprising a power deriver to derive a power supply from an inductively coupled magnetic field.

3. A near field RF communicator according to claim 1, wherein the regulator controller is operable to control the voltage regulator in dependence upon whether or not a RF field with which the near field RF communicator is inductively coupled is carrying data.

4. A near field RF communicator according to claim 1 wherein the regulator controller is operable to control operation of the voltage regulator in dependence upon at least one of the amplitude (or strength) of the magnetic field and the presence of modulation.

5. A near field RF communicator according to claim 1 wherein the regulator controller is operable to prevent operation of the voltage regulator in the event at least one of a magnetic field amplitude below a predetermined level and the presence of modulation.

6. A near field RF communicator according to claim 1, wherein the regulator controller comprises at least one of: a gap detector to detect a break or interruption of an RF field; and a modulation indicator to indicate the presence of modulation.

7. A near field RF communicator according to claim 1, wherein the voltage regulator comprises an error amplifier.

8. A near field RF communicator having: an inductive coupler to enable inductive coupling with a magnetic field of an RF signal; a demodulator to extract modulation from an inductively coupled magnetic field; an error amplifier operable to control a voltage of the near field RF communicator on the basis of a comparison of a reference voltage with a further voltage; a modulator operable to modulate an inductively coupled magnetic field with data to be communicated via the inductive coupling; and an error amplifier controller to inhibit operation of the error amplifier in the event of at least one of a magnetic field amplitude (or strength) below a predetermined level and the presence of modulation.

9. A near field RF communicator according to claim 8 comprising a power deriver to derive a power supply from an inductively coupled magnetic field said further voltage being related to a voltage derived by the power deriver.

10. A near field RF communicator according to claim 8, wherein the error amplifier controller comprises at least one of a modulation indicator to indicate modulation by the modulator and a gap detector to detect a gap or interruption in an inductively coupled magnetic field.

11. A near field RF communicator according to claim 8, wherein the error amplifier controller comprises a modulation indicator to indicate modulation by the modulator and a gap detector to detect a gap or interruption in an inductively coupled magnetic field, each coupled to control at least one switch to cause disconnection of the error amplifier. in the event of an indication of modulation by the modulator or detection of a gap or interruption in an inductively coupled magnetic field.

12. A near field RF communicator according to claim 8, wherein the error amplifier is operable to control an impedance coupled in parallel across the inductive coupler.

13. A near field RF communicator according to claim 16, wherein the impedance comprises at least one of a transistor element and at least one MOSFET.

14. An NFC communicator comprising: an antenna to inductively couple to the H field of an RF signal; a power provider to provide a first power supply for the NFC communicator independent of any inductively coupled signal; a power deriver to derive a second power supply for the NFC communicator from an RF signal inductively coupled to the antenna; and a regulator to regulate a voltage supplied by at least one of the first and second power supplies.

15. An NFC communicator according to claim 14, further comprising a selector to select the second power supply in the event that at least one of: the first power supply is incapable of supplying a power supply sufficient for at least part of the NFC communicator; and the second power supply provides a voltage higher than the first power supply.

16. An NFC communicator according to claim 14, wherein the voltage regulator comprises an error amplifier to compare a voltage of the at least one of the first and second power supplies with a reference voltage.

17. An NFC communicator according to claim 14, wherein the voltage regulator comprises an error amplifier coupled to compare a voltage of the at least one of the first and second power supplies with a reference voltage and a shunt impedance having an impedance controllable by an output of the error amplifier.

18. An NFC communicator according to claim 15, wherein the voltage regulator comprises an error amplifier having a first input coupled to a supply voltage output of the selector, a second input coupled to a reference voltage source and an output, and a transistor having first and second main electrodes providing a shunt current path and a control electrode coupled to the output of the error amplifier to control the impedance of the shunt current path.

19. An NFC communicator according to claim 15, wherein the selector is operable to select the one of the first and second power supplies providing the highest voltage.

20. An NFC communicator according to claim 14, wherein the power deriver comprises a rectifier to provide a rectified voltage from the H field of an RF signal inductively coupled to the antenna wherein the rectifier comprises at least one of: one or more diodes; and one or more diode-coupled transistors.
